(19) United States
(12) Patent Application Publication
(10) Pub. No.: US 2005/0172009 A1
(43) Pub. Date: Aug. 4, 2005

(54) Server system for performing communication over wireless network

(75) Inventors: Young Hoon Roh, Seoul (KR); Jung Ho Kim, Seoul (KR); Jin Cheol Cho, Seoul (KR); Jae Won Chang, Seoul (KR); Sang Hyuk Kang, Pusan (KR); Sang Mahn Kim, Kyunggi-do (KR); Pan Su Kim, Kyunggi-do (KR); Kwang Hui Hong, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc.,, Seoul (KR)

(21) Appl. No.: 10/896,847

(22) Filed: Jul. 23, 2004

(30) Foreign Application Priority Data
Jan. 29, 2004 (KR) 2004-5682

(51) Int. Cl. G06F 15/16

(52) U.S. Cl. 709/219

(57) ABSTRACT

Disclosed is a server system for performing communication over a wireless network that can avoid data transmission delay due to the variation of a wireless network state and can carry out a real-time transmission operation. A network renderer provided in a server device includes a separate ring buffer so that it can be functionally separated from an encoder. Alternatively, the network renderer includes a thread transmission module for discarding part of data according to the network state and carrying out a thread transmission operation. Therefore, the server system avoids transmission delay due to the variation of a wireless network environment or data loss/error due to encoding delay caused by data congestion in the encoder. Moreover, the server system can perform stable wireless communication, thereby enabling a client device to reproduce real-time data.

### BACKGROUND OF THE INVENTION

1. Field of the Invention

The present invention relates to a server system for performing communication over a wireless network, and more particularly to a server system for performing communication over a wireless network that can avoid the delay of data transfer at a transmitting/receiving side according to the variation of a wireless network state, that can separate an encoder for encoding streaming data from a network renderer for transmitting the data to perform real-time transmission, and that can ensure the stability of data transmission over the wireless network by implementing a buffer or a thread transmission module in the network renderer.

2. Description of the Related Art

FIG. 1 is a block diagram illustrating a conventional server system for performing communication over a wireless network. Conventional drawbacks will be described with reference to FIG. 1.

The server system for performing communication over the wireless network basically includes a server device 10 and one or more client devices, e.g., client devices 20a and 20b. As the server device 10 and the client devices 20a and 20b transmit and receive data over the wireless network, a wireless network modem is mounted in the server device 10 and the client device 20a and 20b.

The server device 10 sends moving picture data, etc. as well as normal text data in response to a request of the client device 20a or 20b capable of transmitting and receiving data over the wireless network. In particular, when large-capacity moving picture data is sent, the server device 10 compresses the data and then sends the compressed data.

Therefore, a memory for storing data can be efficiently utilized and also transmission load on an unstable wireless network due to frequency interference can be reduced.

Although a data compression rate is highly increased when the client device 20a or 20b desires to receive predetermined data such as a broadcast stream, etc. from the server device 10 in real time, transmission delay and playback delay can be caused by instability of the wireless network.

When the client device 20a or 20b can be a mobile terminal such as a web pad, a personal digital assistant (PDA) or etc. rather than a fixed device, data transmission load can abruptly increase. When corresponding data is transmitted in a state where the client device 20a or 20b is significantly spaced from the server device 10 or interference of a different radiowave device is incurred during data communication, bandwidth is reduced and hence data transmission delay occurs. Consequently, playback delay in the client device 20a or 20b can be caused by the transmission delay.

When the corresponding data is streaming data to be transmitted in real time, sufficient transmission bandwidth must be ensured so that data loss and error due to time delay can be avoided.

For this, a buffer B is typically employed as shown in FIG. 2.

That is, after the wireless network operates normally and the transmission bandwidth is sufficiently ensured so that a transmission operation can be stably performed when transmission delay is caused by the variation of a wireless network state, the server device 10 at the transmitting side temporarily buffers delayed data in the buffer to transmit the buffered data to the client device 20a or 20b.

The conventional server device 10 includes an encoder 11 for compressing transmission data. The encoder 11 includes a hardware buffer B for buffering the data compressed in real time.

A network renderer 12 connected to the encoder 11 receives the data buffered in the buffer B and then transmits the received data to the wireless network. The network renderer 12 is a kind of network modem.

In a structure of the conventional server device 10 shown in FIG. 2, the encoder 11 for encoding data to be transmitted operates in a state where it is interworking with the network renderer 12 for transmitting the encoded data. Thus, if transmission bandwidth is reduced due to the variation of a wireless network environment, there is a problem in that the data loss can be caused by an overflow of the buffer B provided in the encoder 11.

Moreover, when transmission delay is caused by the overflow of the encoder buffer B, reception delay and playback delay occur in the client device 20a or 20b at the receiving side. For this reason, there is another problem in that real-time streaming data transmission to a television (TV), radio, etc. becomes very unstable.

### SUMMARY OF THE INVENTION

Therefore, the present invention has been made in view of the above problems, and it is an object of the present invention to provide a server system that can avoid data loss due to transmission delay by providing a separate buffer in a network renderer of a server device, and that can avoid an error/delay of data transmission due to the variation of a wireless network environment and transmit streaming data in real time by implementing a thread transmission module in the network renderer, such that more stable wireless communication can be performed.

In accordance with one aspect of the present invention, the above and other objects can be accomplished by the provision of a server system for performing communication over a wireless network, comprising: at least one client device for transmitting and receiving data over the wireless network constructed within a building; and a server device for performing a state monitoring or controlling operation for the at least one client device, wherein the server device comprises: an encoder for encoding data to be transmitted to the client device according to a predetermined protocol; and a network renderer comprising a buffer implemented by software for temporarily storing the encoded data from the encoder when data congestion is caused by reduced transmission bandwidth of the wireless network.

In accordance with another aspect of the present invention, there is provided the server device comprising: an encoder for encoding data to be transmitted to the client device according to a predetermined protocol; and a network renderer comprising a thread transmission module implemented by software for generating a thread so that pieces of the data transferred from the encoder can be simultaneously transmitted and automatically discarding part of the data when data congestion is caused by reduced transmission bandwidth of the wireless network.

The server device acts as a device capable of controlling or monitoring at least one client device coupled thereto over a network constructed within a home, and transmits predetermined data received over the Internet, an antenna or a cable network or transmits predetermined data provided in a database to the client device in a wireless fashion.

The client device performs data communication with the server device in the wireless fashion, transmits a control signal for a real-time streaming data request, and receives data transmitted in the wireless fashion from the server device to reproduce the received data.

Here, the encoder provided in the server device comprises a buffer for storing data after a data compression operation or a data conversion operation based on a communication protocol is carried out, thereby avoiding the loss of transmission data.

Moreover, the network renderer provided in the server device transmits the encoded data to a corresponding client device using a Bluetooth or wireless local area network (LAN) communication protocol in the wireless fashion. The network renderer comprises a communication module for receiving a request signal or a control signal from the client device. This communication module can be differently applied according to a communication protocol. The present invention is not limited to the above description.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a conventional server system for performing communication over a wireless network;

FIG. 2 shows a block diagram for explaining data flow in the conventional server system;

FIG. 3 is a block diagram illustrating a server system for performing communication over a wireless network in accordance with a first embodiment of the present invention; and

FIG. 4 is a block diagram illustrating the server system for performing communication over the wireless network in accordance with a second embodiment of the present invention.

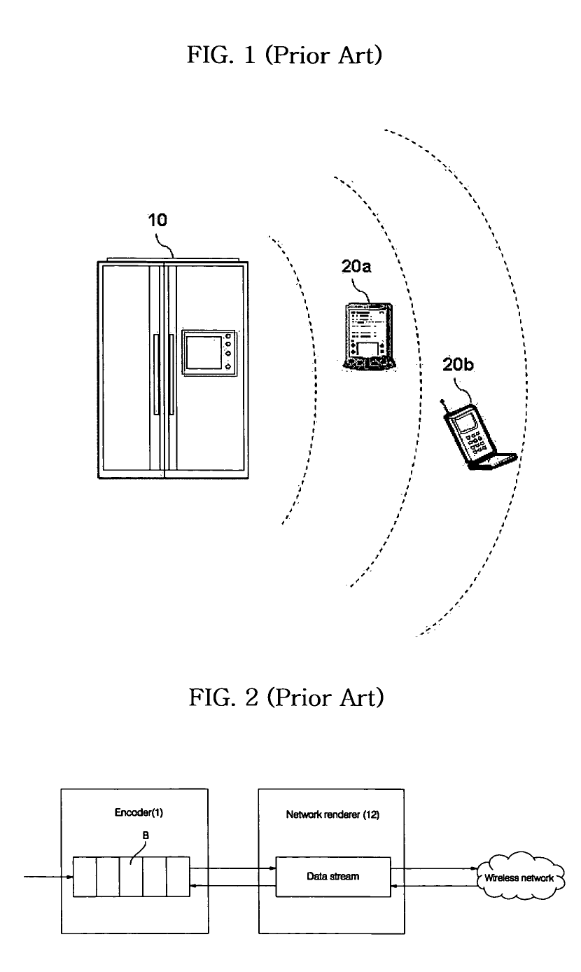

### DESCRIPTION OF THE PREFERRED EMBODIMENTS

Now, a server system for performing communication over a wireless network in accordance with preferred embodiments of the present invention will be described in detail with reference to the annexed drawings.

The server system in accordance with the present invention can be implemented by various embodiments. Hereinafter, the best embodiments will be described. Because basic components of the inventive server system are the same as the conventional components, the identical components will not be described in detail.

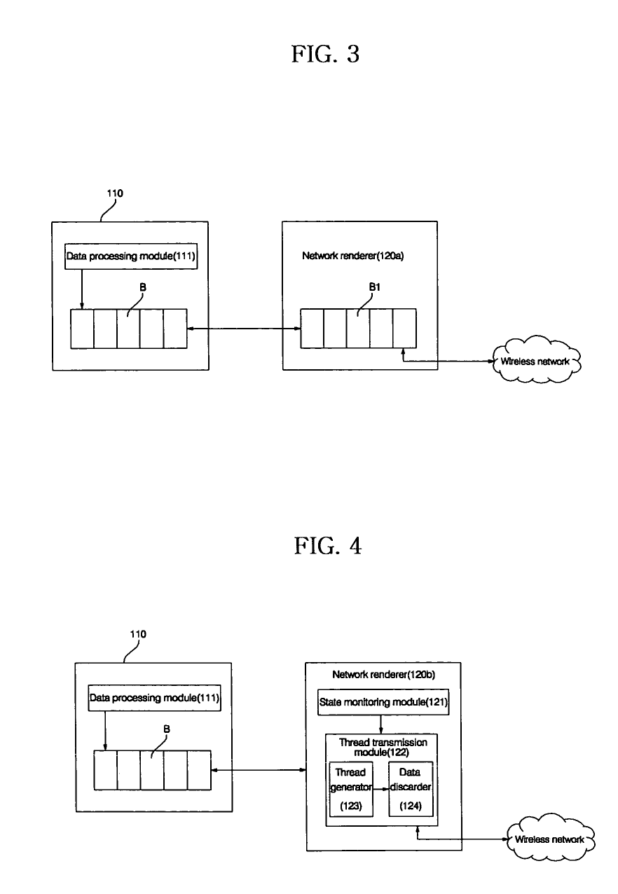

FIG. 3 is a block diagram illustrating a server system for performing communication over a wireless network in accordance with a first embodiment of the present invention; and FIG. 4 is a block diagram illustrating the server system for performing communication over the wireless network in accordance with a second embodiment of the present invention.

A server device acts as a device capable of controlling or monitoring at least one client device coupled thereto over a network constructed within a home. This embodiment exemplarily defines the server device as an Internet-based refrigerator. The server device can perform data communication with each client device in a wired or wireless fashion. However, it is assumed that data is transmitted and received in the wireless fashion in this embodiment.

As the client device performs data communication with the server device in the wireless fashion, it transmits a control signal used for a real-time streaming data request to the server device. For example, a portable web pad capable of being attached to or separated from the Internet-based refrigerator is used in this embodiment.

The portable web pad can communicate with the Internet-based refrigerator in the wireless fashion within a predetermined radius, and has different transmission bandwidth according to an access radius. That is, as the web pad is closer to the Internet-based refrigerator, the transmission bandwidth increases and hence the transmission rate rises. On the other hand, as the web pad is farther from the Internet-based refrigerator, the transmission bandwidth is reduced and hence the transmission rate is lowered.

A wireless network modem can be mounted in the server device and the client device for the wireless communication, and is referred to as a network renderer 120a or 120b.

In this case, the network renderers 120a and 120b can employ a different network modem according to a communication protocol of data transmitted and received in the wireless fashion. Typically, a Bluetooth communication module for transmitting and receiving data using the Bluetooth communication protocol or a wireless local area network (LAN) communication module for transmitting and receiving data using the wireless LAN communication protocol can be applied to the network renderer 120a or 120b.

The server device receives requested data through a medium such as a television (TV), an Internet network or a cable network according to a request of the client device, and transmits the requested data to the client device in real time.

In this case, the server device comprises an input/output unit for a user interface and a database storing state information of the client device coupled to a wired or wireless network, network information, user information and multimedia data. Furthermore, the server device comprises a controller for controlling signal flow so that a corresponding operation can be carried out in response to an inputted control command or a request of the client device.

Moreover, the server device comprises: an encoder 110 for encoding data to be transmitted to the client device over the wireless network; and the network renderer 120a or 120b for transmitting the data processed by the encoder 110 over the wireless network. FIGS. 3 and 4 shows the encoder 110 and the network renderers 120a and 120b responsible for wireless data transmission.

First, the encoder 110 comprises a data processing module 111 for compressing and encoding data received from the database or an external medium, and carrying out a data conversion operation according to a predetermined communication protocol adopted for the wireless transmission and reception; and a buffer B for temporarily storing processed data before it is transferred to the network renderer 120a or 120b.

The first embodiment shown in FIG. 3 and the second embodiment shown in FIG. 4 can be employed according to a method for implementing the network renderer. The first embodiment is a method for implementing the network renderer using a buffer B1, and the second embodiment is a method for implementing the network renderer using a thread transmission module 122.

First, the network renderer 120a shown in FIG. 3 buffers data transferred from the encoder 110 in the buffer B1 implemented by software. Because the network renderer 120a uses the independent buffer B1 provided therein without sharing the encoder buffer B, the loss of data from the encoder 110 and a system error can be overcome even though transmission delay occurs.

When the encoder 110 continuously transfers encoded data to the network renderer 120a despite that the transmission bandwidth of the wireless network has been reduced, the transferred data is temporarily stored in the separately provided buffer B1, such that the data loss can be avoided.

In this case, the buffer B1 provided in the network renderer 120a is a ring buffer, and stores received packets in units of 256-byte pages in a circular mode.

The present invention improves the prior art in that transmission delay due to the variation of a network state does not affect the encoder in the first embodiment and data loss can be reduced. However, because data delay can be incurred as the buffer is used, the first embodiment is not appropriate for real-time data stream transmission.

In case of the second embodiment proposed by the present invention, the network renderer 120b performs a thread transmission operation after selectively discarding data received from the encoder 110 according to variation of the transmission bandwidth.

Here, a thread can indicate a single sequential flow of control within a program. The thread transmission module implemented in the server device is based on a programming technique implemented by software so that one or more processes can be simultaneously executed.

The thread transmission module 122 based on the thread-related technique avoids time delay at every beginning/end cycle of a transmission process, such that pieces of data transferred from the encoder 110 can be simultaneously processed according to a thread transmission operation.

In this case, the thread transmission module 122 transmits only part of data transferred from the encoder 110 and discards the remaining part of data when the transmission bandwidth is reduced due to the variation of a wireless network state, such that data transmission can be rapidly performed in spite of the variation of a wireless network state and hence real-time transmission can be appropriately performed.

For this, the network renderer 120b further comprises a state monitoring module 121 for checking the transmission bandwidth in the wireless network, and transferring a result of the checking to the thread transmission module 122.

Moreover, the thread transmission module 122 comprises a thread generator 123 for generating a thread to be transmitted, and a data discarder 124 for automatically discarding part of data when it is determined that the transmission bandwidth is reduced and data congestion is incurred as the result of the checking.

Of course, both the ring buffer B1 based on the first embodiment and the thread transmission module 122 can be implemented in the network renderer 120b. This can be referred to as a third embodiment.

As apparent from the above description, the present invention provides a server system for performing communication over a wireless network that can avoid data loss/error due to the variation of a wireless network state or encoding delay in an encoder by functionally separating the encoder and a network renderer, thereby stably performing wireless communication.

Moreover, as a thread transmission module is implemented in the network renderer, real-time streaming data can be transmitted, playback delay in a client device at a receiving side can be avoided, and hence real-time wireless communication can be achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Patent Application No. 10-2004-0005682, filed on Jan. 29, 2004, the contents of which are herein expressly incorporated by reference in its entirety.

1. A server system for performing communication over a wireless network, comprising:
at least one client device for transmitting and receiving data over the wireless network constructed within a building; and
a server device for performing a state monitoring or controlling operation for the at least one client device,
wherein the server device comprises:
an encoder for encoding data to be transmitted to the client device according to a predetermined protocol; and
a network renderer comprising a buffer implemented by software for temporarily storing the encoded data from the encoder when data congestion is caused by reduced transmission bandwidth of the wireless network.

2. The server system according to claim 1, wherein the encoder comprises:
a data processing module for carrying out a data compression operation or a data conversion operation based on a communication protocol.

3. The server system according to claim 1, wherein the encoder comprises:
a buffer for buffering the data after a data compression operation or a data conversion operation based on a communication protocol is carried out.

4. The server system according to claim 1, wherein the buffer is a ring buffer for storing the encoded data in a circular mode.

5. The server system according to claim 1, wherein the network renderer is a Bluetooth communication module for transmitting and receiving data using a Bluetooth communication protocol.

6. The server system according to claim 1, wherein the network renderer is a wireless local area network (LAN) communication module for transmitting and receiving data using a wireless LAN communication protocol.

7. A server system for performing communication over a wireless network, comprising:
at least one client device for transmitting and receiving data over the wireless network constructed within a building; and
a server device for performing a state monitoring or controlling operation for the at least one client device,
wherein the server device comprises:
an encoder for encoding data to be transmitted to the client device according to a predetermined protocol; and
a network renderer comprising a thread transmission module implemented by software for generating a thread so that pieces of the data transferred from the encoder can be simultaneously transmitted and automatically discarding part of the data when data congestion is caused by reduced transmission bandwidth of the wireless network.

8. The server system according to claim 7, wherein the network renderer further comprises:
a state monitoring module for checking the transmission bandwidth of the wireless network and transferring a result of the checking to the thread transmission module.

9. The server system according to claim 8, wherein the thread transmission module comprises:
a thread generator for generating the thread; and
a data discarder for automatically discarding the part of the data when it is determined that the data congestion is caused by the reduced transmission bandwidth of the wireless network.

10. The server system according to claim 7, wherein the encoder comprises:
a data processing module for carrying out a data compression operation or a data conversion operation based on a communication protocol.

11. The server system according to claim 7, wherein the encoder comprises:
a buffer for buffering the data after a data compression operation or a data conversion operation based on a communication protocol is carried out.

12. The server system according to claim 11, wherein the buffer is a ring buffer for storing the encoded data in a circular mode.

13. The server system according to claim 7, the network renderer further comprises:
a ring buffer implemented by software for temporarily storing the data transferred from the encoder when the data congestion is caused by the reduced transmission bandwidth of the wireless network.

14. The server system according to claim 7, wherein the network renderer is a Bluetooth communication module for transmitting and receiving data using a Bluetooth communication protocol.

15. The server system according to claim 7, wherein the network renderer is a wireless local area network (LAN) communication module for transmitting and receiving data using a wireless LAN communication protocol.
